(19) United States
(12) Patent Application Publication
(10) Pub. No.: US 2014/0120997 A1
(43) Pub. Date: May 1, 2014

(54) Poker Style Card Game Method and System

(71) Applicant: John Colacone, Cranston, RI (US)

(72) Inventor: John Colacone, Cranston, RI (US)

(21) Appl. No.: 14/059,793

(22) Filed: Oct. 22, 2013

Related U.S. Application Data
(60) Provisional application No. 61/718,216, filed on Oct. 25, 2012.

(51) Int. Cl. G07F 17/32; A63F 1/00

(52) U.S. Cl. CPC G07F 17/3293; A63F 1/00
USPC 463/13; 273/292

(57) ABSTRACT

A card game method and system for Texas Hold'em includes a game surface with a plurality of playing positions. The playing surface includes a main bet wagering area to allow a player to wager on an outcome of the game prior any cards being dealt. The dealer and each player are dealt two hold cards. A second wager area is provided on the game surface to receive a second bet on the outcome of the game to be made after the flop. A third wager area is provided on the game surface to receive a third bet on the outcome of the game to be made after the turn. Upon conclusion of dealing, the winner as between each player hand and the dealer hand is determined. If the player hand beats the dealer hand the dealer meets the threshold qualifying requirement, the player is paid on both the main bet and any second and/or third bets at a value equal to the amount of the money wagered. If the player hand beats the dealer hand and the dealer does not meet the threshold qualifying requirement, the player is paid in an amount equal to half the value of the wagered main bet.

### CROSS REFERENCE TO RELATED APPLICATIONS

This application claims priority to U.S. Provisional Patent Application Ser. No. 61/718,216 filed Oct. 25, 2012, entitled “One Bet Threat Texas Hold'em Poker”, the entire disclosure of which is hereby incorporated by reference as though set forth fully herein.

### TECHNICAL FIELD

The present disclosure relates generally to a casino wagering game that utilizes cards to determine the outcome. More particularly, the present disclosure relates to a variant of a Texas hold'em poker style card game where players may wager on an outcome as determined against a dealer.

### BACKGROUND OF THE INVENTION

Many different wagering games presently exist for use in both home and casino environments. It is desirable that these games are exciting, uncomplicated and easy to learn so as to avoid frustrating the players and encourage continued play. Furthermore, these games typically provide numerous wagering opportunities for players, thus increasing player participation and excitement. It is also desirable that the games move fairly quickly to maintain player interest. To be widely accepted, games typically must provide some or all of these features.

Poker games in particular have gained widespread popularity due to the excitement that they provide as well as the fact that they are relatively uncomplicated and employ well known rules. Over time, to maintain or increase player excitement and interest, many variations in the play of poker-type games have been introduced. Many of these variant poker-type card games have also become very successful and can be played in casinos throughout the U.S.

In more traditional forms of poker, players play against other players with a highest ranking hand as determined by conventional poker hand rankings winning the round. For example, Texas Hold em is a game in which players compete against other players to make a best five-card hand from seven available cards. As the game is played, after the first round of wagering, each player is dealt two hole cards. After viewing the two hole cards, each player is given the opportunity to make an additional wager. The additional wager must at least match the opening bet for the round. A player may match the amount of the additional wager, check if no additional wager is made or fold. The dealer then deals three community cards, which are referred to as the “flop”. Thereafter, another round of betting takes place. Then, the dealer deals a fourth community card (called the “turn”) and another round of betting takes place. The dealer then deals the final community card (called the “river”). A final round of betting then takes place and each player's hand is determined by their five best cards from their own hand and the five community cards to identify the winner. With some games, the player with the highest hand wins the pot. In some forms of the game, the pot is split so that the second best hand wins a bad beat award of 20% of the pot, for example, and the player with the highest hand wins 80% of the pot.

Many of the poker-type variants mentioned above are played against a dealer hand. This allows the casino to make money off these types of games. Also, variations in wagering structures and side bets have also been developed to attract increase player interest. However, it would still be desirable to provide novel variations to existing poker-style games, including different wagering opportunities to attract increased player interest.

### SUMMARY OF THE INVENTION

It is therefore an aspect of the present disclosure to provide a wagering card game that is played generally according to the rules of Texas hold'em.

It is another aspect of the present disclosure to provide a wagering card game that provides increased player excitement and enjoyment.

It is still another aspect of the present disclosure to provide a wagering card game that is easier to play and understand.

It is a yet another aspect of the present disclosure to provide a wagering card game that is played generally according to the rules of Texas hold'em, but provides increased wagering opportunities and thus more chances for players to win.

It is a further aspect of the present disclosure to provide a wagering card game that can be played both at a table in a casino and electronically.

In accordance with the above and the other aspects of the present disclosure, a method of playing a casino card game is provided where a betting surface has a plurality of individual player positions and a dealer position. The game includes a card shuffler for holding a standard deck of playing cards which is disposed on or adjacent the betting surface. A main bet wagering area is associated with each of the plurality of player positions on the betting surface to allow a player associated with each of the plurality of player positions to wager on an outcome of the game. A second main bet wagering area is also associated with each of the plurality of player positions for receipt of a second bet on the outcome of the game. Additionally, a third main bet wagering area is associated with each of the plurality of player positions for receipt of a third bet on the outcome of the game. A player may place at least one wager in the main bet wagering area associated with their player position. Two hole cards are dealt to each of the plurality of player positions where a wager was received in the main bet wagering area to form one or more individual player hands. At least two hole cards are dealt to the dealer position to form a dealer hand. Five community cards are then dealt into a community card area located on the betting surface. After all cards are dealt, the best five card poker hand for each of the playing positions and the dealer position is identified. A winning hand between each of the player positions as compared to the dealer position to determine any winning player hands is then identified. If the dealer hand meets a threshold qualifying requirement, the winning player hand is paid on the main bet and any second bet and/or third bets. If the dealer hand does not meet the threshold qualifying requirement.

### BRIEF DESCRIPTION OF THE DRAWINGS

These and other features and aspects of the present disclosure will become more readily appreciated when considered in connection with the following detailed description and appended drawings, wherein:

FIG. 1 is a perspective view of an exemplary layout for a wagering card game system in accordance with an aspect of the present disclosure;

FIG. 2 is a schematic block diagram of a wagering card game system in accordance with another aspect of the disclosure; and

FIG. 3 is a schematic flow chart illustrating a method of playing a wagering card game in accordance with an aspect of the disclosure.

### DETAILED DESCRIPTION OF THE DISCLOSURE

The gaming system and methods described in this disclosure may be played in a number of different formats such as live action casino table gaming format with a live dealer and real playing cards and chips, or with various automated formats with partial (e.g., wagers only) or complete (wagers, cards, dealer, etc.) automation of the format. Such formats can include traditional video gaming apparatus and modern multi-player platforms.

According to an aspect of the disclosure, an exemplary table game system 10 is provided for facilitating a wagering game for multiple players. The table game system 10 includes a game surface 12 with a game layout 14 disposed on the game surface 12. The game layout 14 can include a plurality of player positions 16 to accommodate players of the game and where a player's hand may be dealt. As shown, the game layout 14 can include six (6) player positions, which are uniformly spaced about a periphery of one side of the game surface 12. The game layout 14 may also include card placement indicia associated with each player position 16 for receipt of the player's hole cards. However, it will be appreciated that the game layout may employ more or less player positions and may have a variety of different configurations and features. Additionally, the layout 14 can also include a dealer position 18 opposite the player positions 16 where a dealer of the game can be stationed and to accommodate the dealer's hand.

According to an aspect, the game layout 14 may include a plurality of wagering areas associated with each of the player positions 16 that allow a player to wager or bet on an outcome of their hand against the dealer's hand. For example, the game layout 14 may include three separate wagering areas associated with each player position 16 that allow a player to place a bet on the event of their hand beating the dealer's hand. According to an aspect, the game layout 14 may include a first wagering area 20, which may be a 1 bet threat Texas hold'em wager area for placement of a main bet (1 bet threat wager), as is discussed in more detail below. According to another aspect, the game layout 14 may include a second wagering area 22, which may be a 2× main bet wagering area for placement of a wager that is 2 times the amount of the 1 bet threat wager, as is discussed in more detail below. According to a further aspect, the game layout 14 may include a third wagering area 24, which may be a call bet wagering area for placement of a wager in the amount of the 1 bet threat wager, as is discussed in more detail below. As shown, these wagering areas may be oriented in a straight line. Obviously, the location and orientation of these wagering areas may vary. Moreover, any number of wagering areas may be employed that allow a player to wager on the outcome of the game. Further, the amounts permitted to be wagered by players in each wagering area, may also vary.

As shown, the game layout 14 may include a fourth wagering area 26 for placement of a first optional bonus wager. According to an aspect, the first optional bonus wagering area may be a bet that the player wins if the player's hole cards are a pocket pair, as is discussed in more detail below. As shown, the layout 14 may also include a fifth wagering area 28 for placement of a bet on the player's final hand, as is discussed in more detail below. According to a further aspect, the table game system 10 may include a chip rack 30 for holding chips that the dealer may use to pay out winning wagers to store chips gathered from losing wagers. The table game system 10 may additionally include a card shuffling device 5 for holding cards and allowing a dealer to remove them and deal to the players stationed at several of the player positions 16. The card shuffling device 5 is preferably configured to hold a single standard deck of cards having 52 individual cards. However, it may be used to hold more or less cards and/or cards from custom decks.

The game layout 14 can also include five individual card areas 32 for receipt of the community cards dealt by the dealer. Additionally, the game layout 14 may also include two dealer card area indicia 34 for receiving the dealer's cards. Alternatively, the dealer card area indicia may be omitted from the game layout 14.

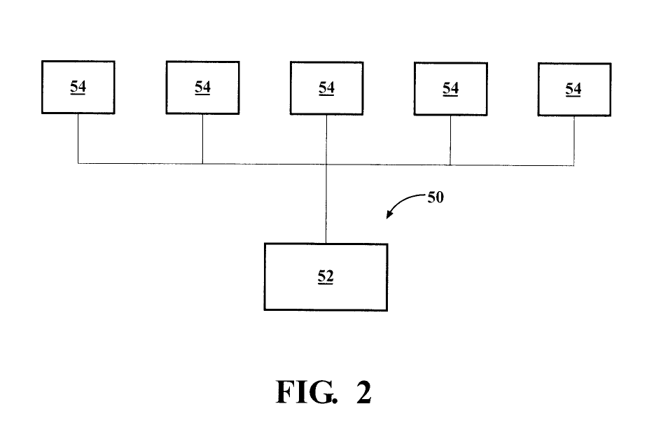

FIG. 2 schematically illustrates a table game system 50 in accordance with another aspect. According to this aspect, the table game system 50 can include a server 52 on which software is housed which allows the system to operate according to the present disclosure. The server 52 may be in communication with a plurality of computers 54 such that a game layout, similar to that discussed above, may be displayed on a screen associated with each of the plurality of computers 54. The computers may be configured to allow players to interact therewith, such as through a touch screen or other input device, i.e., a mouse. Through these interactions, players may make wagers, including those discussed herein. The computers 54 may be located remotely from the server 52 to allow players to interact with the table game system 50 from distant locations. The computers 54 may in communication with the server in a variety of different ways, including wirelessly or over the internet.

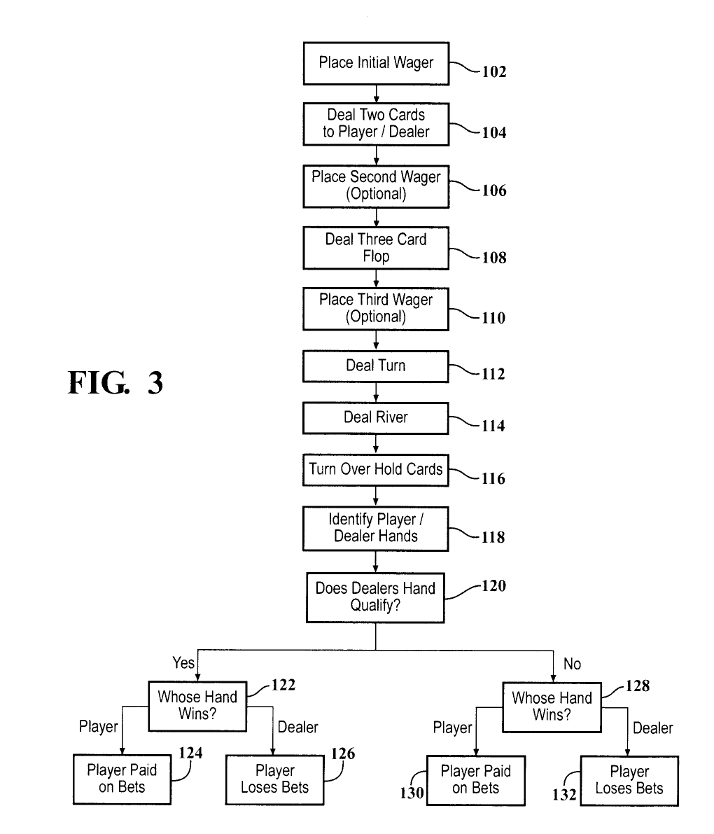

A basic format 100 (whether on a table or automated device, with computer, processor, monitor, cash/credit/token receptors, etc.) is described according to an aspect below with reference to FIG. 3. According to an aspect, each player may place an initial wager in the first wagering area 20, as generally indicated by reference number 102 in order to participate in the game. By this initial wager, which may be referred to as a “1 bet threat wager”, a player may wager that their ultimate five card poker hand will defeat the dealer's five card poker hand as defined by the traditional ranking of poker hands. Once a player makes an initial wager in the first wagering area 20, the player and the dealer will automatically face off with the best five card poker hand after all cards have been dealt. In other words, each player will see all seven cards without folding.

According to this example, once one or more players have made the 1 bet threat wager, the dealer and each player who has made an initial wager in the first wagering area 20 will be dealt two cards, as generally indicated by reference number 104. The hole cards will be dealt to each of the player positions 16 where players have made a 1 bet threat wager. According to an aspect, the player cards may be face up or face down. It will be understood that providing the player cards face down has some intrinsic desirable features for the house. The dealer cards are preferably dealt face down so the players do not know where their hand stands with respect to the dealer hand despite the disadvantage this can provide. Although it is preferred that the dealer and players each receive the same number of cards, the dealer could deal an unequal numbers of cards to the dealer and players, which will alter the house advantage. For example, giving the dealer three cards instead of two cards and allowing the dealer to discard one card would provide a greater advantage to the house.

According to an aspect, once the first two cards have been dealt as indicated by reference number 104, a player may make a wager in the second wagering area 22, as generally indicated by reference number 106. The wager in the second wagering area 22 may be 2x the main bet. For example, a player who believes his two cards yields a good chance of ultimately prevailing against the dealer in a showdown may elect to place a wager in the second wagering area 22 that is equal to twice the initial bet in the first wagering area 20. It will be appreciated that the required amount of the wager in the second wagering area 22 may vary. It will also be appreciated that players do not have any obligation to place a wager in the second wagering area 22 and may opt to check. Such a feature may be beneficial as it allows a player to remain in the game and showdown against the dealer in every hand with only a single bet in wagering area 20.

According to another aspect, as shown schematically by reference number 108, the dealer may then show the three card flop by placing in them in three of the community card positions 32. Prior to dealing and displaying the first three community cards in step 108, which is known as the flop, the dealer may burn a card by taking it off the top of the deck and placing in a discard pile. After the flop, the players have the option to place an additional wager in the third wagering area 24, as generally indicated by reference number 110. The wager in the third wagering area 24 may be equal to the main bet. Again, a player who believes the three community cards when combined with his two hole cards yield a good chance of ultimately prevailing against the dealer in a showdown may elect to place a wager in the third wagering area 24, which is equal in amount to the wager in the first wagering area 20. Again, such a feature may be beneficial as it allows a player to remain in the game and showdown against the dealer in every hand with only a single bet in wagering area 20.

According to a further aspect, the dealer may then display the fourth community card, which is known as the turn, as generally indicated by reference number 112. Again, the dealer may burn a card by taking it off the top of the deck and placing in a discard pile. According to still another aspect, the dealer will then display the fifth community card, which is known as the river, as generally indicated by reference number 114. The dealer may again burn a card by taking it off the top of the deck and placing in a discard pile. It will be appreciated that more or less wagering areas allowing more, less, or different bets may be utilized.

According to the next step, the dealer and player may turn over or reveal their hole cards, as generally indicated by reference number 116. At this point, each dealer and player now has a seven card hand. Each player and the dealer can then identify their best poker hand comprised of five of seven cards (two hole and five community), as generally indicated by reference number 118. In other forms of the disclosure, more or less than five cards are dealt as community cards and the initial display of community cards equals 1, 2, 4, 5 or 6 community cards, rather than three.

As also shown in FIG. 3, once the hands have been identified in step 118, according to an aspect, the next step is to determine if the dealer's hand qualifies, as generally indicated by reference number 120. It will be appreciated that the dealer qualification may be set at a variety of different levels. However, according to one aspect, to qualify the dealer must have a hand of a pair of 6s or higher. The next step is to determine whether the player's hand or the dealer's hand is better, as generally indicated by reference number 122. If the dealer's hand qualifies and the player's hand is higher, the player is paid, as indicated by reference number 124. According to an aspect, under this circumstance, the player is paid even money on the main bet 20 and any call bets 22, 24. It will be appreciated that different payouts may be employed. If the player's hand is lower, the player loses the main bet 20 and the call bets 22, 24, as generally indicated by reference number 126.

If the dealer does not qualify and the player's hand is higher, as determined at step 128, the player is paid, as generally indicated by reference number 130. According to another aspect, under this circumstance, the player is paid half of the main bet. Under this circumstance, the call bets may push. It will be appreciated that different payouts may again be employed as well as different bets may be paid out or pushed. According to an aspect, if, however, the player's hand is lower, the player loses the main bet and the call bets push, as generally indicated by reference number 132. If the dealer hand and the player's hand tie, all bets may be deemed a push. This process 100 may be repeated for each player who made a 1 bet threat wager in the wagering area 20.

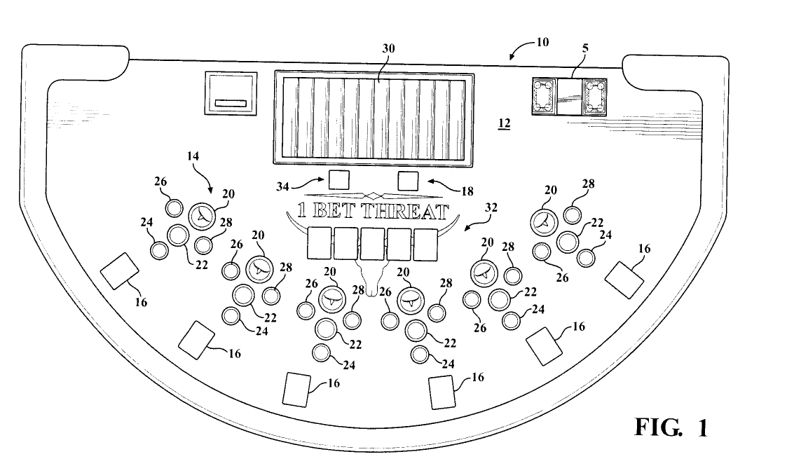

With reference again to FIG. 1, before any cards are dealt, the players may place an optional wager in the fourth wagering area 26, which may be referred to as a pocket pair wager. By this wager, a player may bet that the first two cards (hole cards) dealt to the player will be a pair. After the cards have been revealed, the dealer may identify any players that placed a wager in the fourth wagering area 26 and then determine if their first two cards (hole cards) are a pair. If so, the player may be paid according to payouts, which may be determined according to exemplary pay tables as set forth below:

| | | | |
|---|---|---|---|
| AA | 30 to 1 | 40 to 1 | 50 to 1 |
| JJ, QQ, KK | 25 to 1 | 25 to 1 | 20 to 1 |
| 2,2 to 10,10 | 10 to 1 | 8 to 1 | 8 to 1 |

It will be appreciated that different payouts may be employed.

With reference again to FIG. 1, before any cards are dealt, the players may place another optional wager in the fifth wagering area 28, which may be referred to a final hand wager. By this wager, a player may bet that their final hand consists of Jacks-High Two Pair or better. Thus, after all cards have been dealt, the dealer may identify any players that placed a wager in the fifth wagering area 28 and then determine if the hand includes Jacks-High Two Pair or better. If so, the player may be paid according to payouts which may be determined according to exemplary pay tables as set forth below:

| HAND | PAY TABLE A | PAY TABLE B | PAY TABLE C |
|---|---|---|---|
| Royal Flush | 250 to 1 | 250 to 1 | 100 to 1 |
| Straight Flush | 50 to 1 | 50 to 1 | 50 to 1 |
| Four-of-a-kind | 10 to 1 | 15 to 1 | 12 to 1 |
| Full House | 6 to 1 | 5 to 1 | 5 to 1 |
| Flush | 4 to 1 | 4 to 1 | 4 to 1 |
| Straight | 3 to 1 | 3 to 1 | 3 to 1 |
| Three-of-a-kind | 2 to 1 | 2 to 1 | 2 to 1 |
| Two Pair | 1 to 1 | 1 to 1 | 1 to 1 |

It will be appreciated that different payouts may be employed. It will also be appreciated that different wagers may be made available to players.

Note that not all of the activities described above in the general description or the examples are required, that a portion of a specific activity may not be required, and that one or more further activities may be performed in addition to those described. Still further, the orders in which activities are listed are not necessarily the order in which they are performed.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Many other embodiments may be apparent to those of skill in the art upon reviewing the disclosure. Other embodiments may be used and derived from the disclosure, such that a structural substitution, logical substitution, or another change may be made without departing from the scope of the disclosure. Accordingly, the disclosure is to be regarded as illustrative rather than restrictive.

Certain features are, for clarity, described herein in the context of separate embodiments, may also be provided in combination in a single embodiment. Conversely, various features that are, for brevity, described in the context of a single embodiment, may also be provided separately or in any sub combination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method of playing a casino card game, comprising:
providing a betting surface having a plurality of individual player positions and a dealer position;
providing a card shuffler for holding a standard deck of playing cards, the card shuffler being disposed on or adjacent the betting surface;
providing a main bet wagering area associated with each of the plurality of player positions on the betting surface to allow a player associated with each of the plurality of player positions to wager on an outcome of the game;
providing a second main bet wagering area associated with each of the plurality of player positions for receipt of a second bet on the outcome of the game;
providing a third main bet wagering area associated with each of the plurality of player positions for receipt of a third bet on the outcome of the game;
receiving at least one wager in the main bet wagering area associated with at least one of the plurality of player positions;
dealing two hole cards to each of the plurality of player positions where a wager was received in the main bet wagering area to form one or more individual player hands;
dealing at least two hole cards to the dealer position to form a dealer hand;
dealing five community cards into a community card area located on the betting surface;
identifying a best five card poker hand for each of the playing positions and the dealer position;
identifying a winning hand between each of the player positions as compared to the dealer position to determine any winning player hands;
identifying whether a dealer hand meets a threshold qualifying requirement;
paying the winning player hand on the main bet and any second bet and/or third bets if the dealer hand meets the threshold qualifying requirement; and
paying the winner player hand on the main bet only if the dealer hand does not meet the threshold qualifying requirement.

2. The method of claim 1, wherein the casino card game is Texas Hold'em and the five community cards are broken down into the flop, turn and river.

3. The method of claim 2, further comprising:
receiving at least one wager in the main bet wagering area prior to dealing two hold cards.

4. The method of claim 3, further comprising:
receiving any wagers in the second bet wagering area after the flop is dealt.

5. The method of claim 4, further comprising:
receiving any wagers in the third bet wagering area after the turn.

6. The method of claim 1, wherein the step of paying the winning player hand when the dealer hand meets the threshold qualifying requirement includes paying the main bet and any second bet and/or third bet at a value equal to the amount of the money wagered.

7. The method of claim 1, wherein the step of paying the winning player hand when the dealer does not meet the threshold qualifying requirement includes paying the main bet at a value half the amount of the money wagered.

8. The method of 1, further comprising:
providing at least one optional wagering area associated with each of the plurality of player positions.

9. The method of claim 8, further comprising:
receiving a wager in the at least one optional wagering area;
identifying whether the hole cards of the player associated with the wager in the optional wagering area form a pair;
paying the player associated with the wager in the optional wagering area based on a predetermined payout table.

10. The method of claim 8, further comprising:
receiving a wager in the at least one optional wagering area;
identifying whether the hand of the player associated with the wager in the optional wagering area is jacks-high two pair or better;
paying the player associated with the wager in the optional wagering area based on predetermine payout table.

11. A method of playing a casino card game, comprising:
executing, with a processor, a program stored in a memory of a computer implemented device, the program directing the computer implemented device to perform the following:
displaying a betting surface having a plurality of individual player positions and a dealer position;
providing a standard deck of playing cards for playing the game;
providing a main bet wagering area associated with each of the plurality of player positions on the betting surface to allow a player associated with each of the plurality of player positions to wager on an outcome of the game;
providing a second main bet wagering area associated with each of the plurality of player positions for receipt of a second bet on the outcome of the game;
providing a third main bet wagering area associated with each of the plurality of player positions for receipt of a third bet on the outcome of the game;
receiving at least one wager in the main bet wagering area associated with at least one of the plurality of player positions;
dealing two hole cards to each of the plurality of player positions where a wager was received in the main bet wagering area to form one or more individual player hands;
dealing at least two hole cards to the dealer position to form a dealer hand;
dealing five community cards into a community card area located on the betting surface;
identifying a best five card poker hand for each of the playing positions and the dealer position;
identifying a winning hand between each of the player positions as compared to the dealer position to determine any winning player hands;
identifying whether a dealer hand meets a threshold qualifying requirement;
paying the winning player hand on the main bet and any second bet and/or third bets if the dealer hand meets the threshold qualifying requirement; and
paying the winner player hand on the main bet only if the dealer hand does not meet the threshold qualifying requirement;

12. The method of claim 11, further comprising:
receiving at least one wager in the main bet wagering area prior to dealing two hold cards.

13. The method of claim 12, further comprising:
receiving any wagers in the second bet wagering area after the flop is dealt.

14. The method of claim 13, further comprising:
receiving any wagers in the third bet wagering area after the turn.

15. The method of claim 11, wherein the step of paying the winning player hand when the dealer hand meets the threshold qualifying requirement includes paying the main bet and any second bet and/or third bet at a value equal to the amount of the money wagered.

16. The method of claim 11, wherein the step of paying the winning player hand when the dealer does not meet the threshold qualifying requirement includes paying the main bet at a value half the amount of the money wagered.

17. The method of 11, further comprising:
providing at least one optional wagering area associated with each of the plurality of player positions.

18. The method of claim 17, further comprising:
receiving a wager in the at least one optional wagering area;
identifying whether the hole cards of the player associated with the wager in the optional wagering area form a pair;
paying the player associated with the wager in the optional wagering area based on a predetermined payout table.

19. The method of claim 18, further comprising:
receiving a wager in the at least one optional wagering area;
identifying whether the hand of the player associated with the wager in the optional wagering area is jacks-high two pair or better;
paying the player associated with the wager in the optional wagering area based on predetermine payout table.
